(19) United States
(12) Patent Application Publication
(10) Pub. No.: US 2023/0285947 A1
(43) Pub. Date: Sep. 14, 2023

(54) METHOD FOR PREPARING MODIFIED NATURAL WOOD MATERIAL AND APPLICATION THEREOF IN SEWAGE TREATMENT

(71) Applicant: HARBIN INSTITUTE OF TECHNOLOGY, SHENZHEN, SHENZHEN (CN)

(72) Inventors: LU LU, SHENZHEN (CN); WEIXIANG CHAO, SHENZHEN (CN); XINYUE HE, SHENZHEN (CN); RUIJIE YANG, SHENZHEN (CN); YONGJIE YU, SHENZHEN (CN); ZHIDA LI, SHENZHEN (CN); CHENGFENG WAN, SHENZHEN (CN)

(21) Appl. No.: 18/054,152

(22) Filed: Nov. 10, 2022

(30) Foreign Application Priority Data
Mar. 14, 2022 (CN) 202210247986.7

(51) Int. Cl. B01J 31/38; B01J 21/06; B01J 31/06; B01J 35/00; B01J 37/06; B01J 37/04; B01J 37/16; B01J 37/34; B01J 37/02; C02F 1/30; C02F 1/72

(52) U.S. Cl. CPC B01J 31/38; B01J 21/063; B01J 31/061; B01J 35/004; B01J 37/06; B01J 37/04; B01J 37/16; B01J 37/343; B01J 37/0217; B01J 37/0236; C02F 1/30; C02F 1/725; C02F 2305/10; C02F 2303/04

(57) ABSTRACT

The present invention belongs to the field of sewage treatment, and relates to a method for preparing a modified natural wood material and an application thereof in sewage treatment. The method for preparing the modified natural wood material includes the following steps: S1. placing wood into a lignin removal solution, after a heating reaction, washing, impregnating, and lyophilizing the wood to obtain removed lignin wood; S2. blending TiO₂ with NaBH₄, performing low-heat reduction treatment, and then washing and drying to obtain reduced black titanium; S3. dispersing the reduced black titanium ultrasonically in a solvent, then coating dropwise on the removed lignin wood, and drying to obtain a modified natural wood material. The modified natural wood material prepared by the present invention has high disinfection and sterilization performance, and has the ability to remove bio-risk components.

### TECHNICAL FIELD

The present invention belongs to the field of sewage treatment, and relates to a method for preparing a modified natural wood material and an application thereof in sewage treatment.

### BACKGROUND

Water pollution and the shortage of effective freshwater resources are gradually becoming important factors that limit current sustainable development of China. Despite China has an abundant freshwater resource, uneven distribution of water resources remains a significant problem for China at this stage. Per capita water resources of China are only one quarter of world average water resources, making China one of the poorest countries in per capita water resources in the world. Meanwhile, with social and economic development, people's living standards have improved, and pollutant discharge is also exacerbating the shortage of freshwater resources in China. At present, most of China's water resources are subject to different degrees of point source and non-point source pollutions, which greatly limit development and utilization of water resources. At present, a total amount of sewage discharge in China is increasing year by year, and demand for sewage treatment is constantly increasing. In addition to traditional nitrogen, phosphorus, heavy metals and organic pollutants, new pollutants with certain bio-risks such as coliforms, disinfected by-products (DBPs) and antibiotic resistance genes (ARGs) are given with due attention.

A problem of microbial pollution in a water environment is of significance for controlling spread of infectious diseases because of a risk of inducing a disease. A vast majority of microorganisms are present in the water environment in a natural flow way, and mainly from soil flushing, which is generally not pathogenic to humans. However, a part of microorganisms in the water environment are from garbage, human and animal manures, leather or wastewater from a food industry, which contain some risk pathogenic microorganisms. This can lead to diarrhea, typhoid fever, dysentery and other diseases, which are seriously harmful to human health. In addition, in order to prevent and treat infectious diseases caused by bacterial infections in humans and animals, antibiotics are widely used in medical and agricultural fields. However, relevant studies showed that antibiotics are not completely absorbed by humans or animals. After ingestion, more than 50% of antibiotics are excluded from humans or animals in original structures thereof, and more than 40% of antibiotics are excluded from human and animal excrements in a derivative form thereof. Antibiotics enter a municipal drainage network with wastewater. However, a treatment process of a traditional sewage treatment plant does not effectively remove antibiotics in sewage. A large amount of antibiotics are still discharged into natural water bodies, thus affecting structures of microbial communities and an ecological function of the water environment. It should also be noted that since 2010, no new antibiotics have been discovered by humans. This may be because certain drug resistance may be caused due to high use and discharge of antibiotics by environmental microorganisms. Therefore, disinfection treatment is essential in sewage treatment and plays an important role in inactivating pathogenic microorganisms and reducing spread of water-borne infectious diseases.

Traditional disinfection processes mainly include chlorination disinfection, ultraviolet disinfection, and ozone disinfection. Although a chlorination disinfection technology is mature with a low failure rate of an apparatus and a low operating cost, the chlorination disinfection is easy to have a substitution reaction with residual organisms in water to generate halogenated DBPs such as trihalomethane, and chlorine residuals are also easy to cause a certain adverse effect on a water environment ecosystem. The ultraviolet disinfection does not change physical and chemical properties of a water body. Further, the greater an irradiation dose within unit time, the better the disinfection effect. However, a main defect of the ultraviolet disinfection is that no continuous disinfection effect is provided. The ozone disinfection has certain advantages, for example, the ozone disinfection can efficiently decolorize and deodorize sewage, and also has a good disinfection effect on strong drug-resistant microorganisms while being able to reduce the amount of halogenated DBPs generated during a disinfection process. Because of poor stability, being difficult to store and transport, and need to be prepared for use on site, the ozone disinfection has high equipment investment, high electricity consumption, high investment operating costs, and complex operation and management. It should be noted that the above disinfection processes can play a certain role in killing common microorganisms in a water environment, but the removal of bio-risk components such as ARGs is not efficient. Further, high energy consumption and high material input amount make the traditional disinfection processes prone to secondary environmental pollution and increase a sewage treatment pressure. Based on the above problems, the present invention aims to develop a sewage disinfection process with lower costs, low energy consumption and low environmental impact, overcome cost and environmental pressures of current technologies, and provide effective technical support to ensure ecological safety of a water environment.

As one of the most abundant renewable energy sources in nature, solar energy itself contains a certain amount of ultraviolet light band, which can be used for disinfection and sterilization. Energy contained in other bands of a solar energy spectrum can also be used for photothermal sterilization. However, when solar energy acts on overall sewage disinfection, due to a large amount of thermal diffusion and loss, an energy conversion utilization rate is low. In recent years, a photothermal interface is a new solar energy utilization mode to efficiently concentrate solar energy at an air-liquid interface, form a thermal value centralized interface, and evaporate and produce clean fresh water. At the same time, through modification of a modified material, the photothermal interface is capable of inducing a photothermal effect at an irradiation interface and a photoexcited oxygen-containing radical generation process, which can be effectively utilized in the field of disinfection and sterilization after coupling. However, materials currently used are generally a carbon-based nanomaterial, a semiconductor-based material, and a plasmon metal-based material. Problems such as high costs, huge consumption, complex preparation, and easy secondary environmental pollution are provided. When applied to an actual water environment, most of the materials are powders, which are difficult to recover. Because of a nanosize effect of the materials, the materials are also prone to accumulation of environmental toxicity.

Therefore, it is urgently necessary to develop a new photothermal material that is cheap and easy to obtain, has low environmental impact, can be used in a sustainable manner, and can be used in a self-supporting manner. The photothermal effect of the interface, co-action of photoexcited oxygen-containing radical, and an induced enrichment effect of a self-supporting material are utilized to realize efficient disinfection of sewage, and removal of bio-risk components.

### SUMMARY

In order to solve the above problems in the prior art, the present invention discloses a cheap, safe, green, efficient and sustainable modified natural wood material and a method for preparing the same, which are applied to disinfection and sterilization, thus providing a new method and a new idea for removal of bio-risk components in a water body.

An objective of the present invention is to provide a method for preparing a modified natural wood material, including the following steps:

S1. placing wood into a lignin removal solution, after a heating reaction, washing, impregnating, and lyophilizing the wood to obtain removed lignin wood;
blending TiO₂ with NaBH₄, performing low-heat reduction treatment, and then washing and drying to obtain reduced black titanium;

S2. dispersing the reduced black titanium ultrasonically in a solvent, then coating on the removed lignin wood, and drying to obtain a modified natural wood material;
wherein,
the natural wood material is American lightwood;
the reduced black titanium has a bandgap of 2.10-2.20 eV.

The reduced black titanium in the present invention is prepared by a low thermal chemical reduction method of P25 TiO₂. Compared with a ratio of a rutile phase to an anatase phase in an original crystalline form of P25 TiO₂ of 2:8, a rutile phase and an anatase phase in the reduced black titanium prepared by a high thermal reduction method are mixed phases. A crystalline form of the reduced black titanium prepared by the present invention is completely transformed into the rutile phase after a reduction treatment. TiO₂ in the rutile phase has a stronger internal crystalline form structure and a more stable performance, so that effective absorption and utilization of solar energy can be improved within a visible solar energy spectrum.

Further, in step S1, the method for preparing the lignin removal solution includes the following steps: dissolving acetate in water, adjusting pH, and then adding chlorate, stirring to dissolve, and obtaining the lignin removal solution.

Further, a molar ratio of acetate to chlorate is (2.5-3):1.

Further, the pH is 4.4-4.8.

Further, in step S1, the heating reaction has a temperature of 100-120° C. and time of 8-10 h.

Further, in step S1, a molar ratio of TiO₂ to NaBH₄ is (1-1.5):1.

Further, in step S1, the method of blending TiO₂ with NaBH₄ is ball-milling mixing.

Further, in step S1, the low-heat reduction treatment is performed under an inert gas atmosphere at a temperature of 300-350° C. for 1-1.5 h.

Further, in step S2, ultrasonically dispersing time is 20-40 min.

Another objective of the present invention is to provide an application of the above modified natural wood material in sewage treatment.

The present invention has the following beneficial effects:
1. Natural wood selected in the present invention is American lightwood, which is inexpensive and easy to obtain, saves costs, and can be naturally degraded, thus avoiding secondary pollution to an environment. Further, the American lightwood has a rich adsorption hole structure. After lignin removal treatment, a cellulose-based highly chemically active surface of the American lightwood is exposed, and can load reduced black titanium as a photothermally modified component, and efficiently kills microorganisms in sewage by using a solar energy-induced photothermal effect and photoexcited oxygen-containing radical. Meanwhile, a characteristic adsorption hole structure of the American lightwood is used to induce ARGs and other bio-risk components to be enriched in a modified material, which achieves a removal effect, ensures ecological safety of a water environment, and has important significance for development of disinfection and sterilization technologies of a water body.
2. The present invention reduces TiO₂ by using a strong reducing property of −1-valent state H in NaBH₄ to prepare the reduced black titanium, and can fully react at a lower temperature. Preparation conditions are easy to achieve, and energy consumption is low. Reduction of TiO₂ by NaBH₄ is more thorough. A main crystalline form of TiO₂ can be transformed from an anatase phase to a rutile phase. Meanwhile, strong reduction of NaBH 4 can also make P25 TiO₂ form more reduction defect sites, thereby reducing a bandgap width of the resulting reduced black titanium, and further improving a photothermal performance of the modified natural wood material. Compared with a traditional TiO₂ material, the reduced black titanium can significantly improve an absorption response characteristic to visible light, efficiently use absorbed photon energy to induce generation of electron hole pairs, and promote a photocatalytic process while producing a certain calorimetric effect inside a modified composite material. The two effects can be used efficiently and synergistically for sewage disinfection.

### BRIEF DESCRIPTION OF THE DRAWINGS

FIG. 1 shows a diagram of XRD results for detecting reduced black titanium prepared for P25 TiO₂ and step S1 in Embodiment 1.

FIG. 2 shows an ultraviolet-visible diffuse reflection spectrum diagram of reduced black titanium prepared for P25 TiO₂ and step S1 in Embodiment 1.

FIG. 3 shows a diagram of growth results of general microorganisms in Test Embodiment 1; wherein,

FIG. 3(a) shows a diagram of growth test results of general microorganisms in domestic sewage (Blank sample 1);

FIG. 3(b) is a diagram of performance test results of killing general microorganisms with a modified natural wood material prepared in Embodiment 1;

FIG. 3(c) is a diagram of performance test results of killing general microorganisms with a modified natural wood material prepared in Comparative Embodiment 1;

FIG. 3(d) is a diagram of performance test results of killing general microorganisms with a modified natural wood material prepared in Comparative Embodiment 2.

FIG. 4 shows a diagram of growth results of Escherichia coli in Test Embodiment 2; wherein,

FIG. 4(a) is a diagram of growth test results of Escherichia coli in domestic sewage (Blank sample 2);

FIG. 4(b) is a diagram of performance test results of killing Escherichia coli with a modified natural wood material prepared in Embodiment 1;

FIG. 4(c) is a diagram of performance test results of killing Escherichia coli with a modified natural wood material prepared in Comparative Embodiment 1;

FIG. 4(d) is a diagram of performance test results of killing of Escherichia coli with a modified natural wood material prepared in Comparative Embodiment 2.

FIG. 5 shows a diagram of detection results of oxygen-containing radical produced by a modified natural wood material in Test Embodiment 2; wherein,

FIG. 5(a) shows a magnetic field intensity-signal intensity curve of oxygen-containing radical produced by a modified natural wood material under irradiation of one natural light for 1 h;

FIG. 5(b) shows a magnetic field intensity-signal intensity curve of oxygen-containing radical produced by a modified natural wood material under unirradiated conditions.

FIG. 6 shows a diagram of test results of bio-risk components in ARGs in a sample in Test Embodiment 3; wherein,

FIG. 6(a) shows a diagram of test results of bio-risk component contents in domestic sewage (Blank sample 3);

FIG. 6(b) shows a diagram of test results of an enrichment separation effect of bio-risk components of ARGs by a modified natural wood material prepared in Embodiment 1;

FIG. 6(c) shows a diagram of test results of an enrichment separation effect of bio-risk components of ARGs by a modified natural wood material prepared in Comparative Embodiment 1;

FIG. 6(d) shows a diagram of test results of an enrichment separation effect of bio-risk components of ARGs by a modified natural wood material prepared in Comparative Embodiment 2.

### DETAILED DESCRIPTION OF EMBODIMENTS

In order to more clearly describe technical solutions of the present invention, the following embodiments are given, but the present invention is not limited thereto.

Experimental methods used in the following embodiments are all conventional methods unless otherwise specified. Reagents, materials and the like used in the following embodiments can be obtained from commercial routes unless otherwise specified.

Wood in the embodiments of the present invention was American lightwood and purchased from a local wood retail market, and had a size of 30 mm×30 mm×5 mm (length×width×height).

TiO₂ in the embodiments of the present invention was commercial P25 TiO₂.

The method for preparing a lignin removal solution in the embodiments of the present invention had the following steps: dissolving 0.2 mol of sodium acetate in 150 mL of deionized water, adding glacial acetic acid dropwise to adjust pH to 4.6, then adding the deionized water of 300 mL, then adding 0.07 mol of sodium chlorite, stirring and dissolving to obtain the lignin removal solution.

The LB-agar solid culture medium in the test embodiment of the present invention had the following compositions: 10.0 g of peptone, 5.0 g of yeast paste powder, 5.0 g of sodium chloride, 1.0 g of glucose, and 15.0 g of agar per liter of a LB-agar culture medium. The pH was finally adjusted to be 7.0.

The EMB-agar solid culture medium in the test embodiment of the present invention had the following compositions: 10.0 g of peptone, 10.0 g of lactose, 2.0 g of potassium dihydrogen phosphate, 15.0 g of agar, 0.4 g of eosin, and 0.065 g of methylene blue per liter of an EMB-agar culture medium. The pH was finally adjusted to be 7.1.

The plate number of an electron-paramagnetic resonator in the test embodiment of the present invention was Bruker A300.

The method for testing a macrogenome-antibiotic resistance gene in the test embodiment of the present invention had the following steps: firstly, extracting a total DNA of microorganisms from an original sample, then testing a DNA sample, and performing subsequent experiments after a total amount and purity of the DNA sample meet requirements, otherwise, the DNA is re-extracted or an existing DNA is purified according to a specific reason; adding the DNA sample passing a quality test to a breakage buffer, randomly interrupting the DNA with an ultrasonic crusher, applying the interrupted short fragmented DNA to establish a library, quality-testing the library, PE150-sequencing the library passing the quality test by using an Illumina HiSeq 2500 high-throughput sequencing platform, and transforming a raw image data file obtained by the sequencing into an original sequencing sequence by a base recognition analysis. After obtaining macrogenome sequencing data of the original sample, performing quality control of original data, evaluating quality of the data to be sequenced and removing the low-quality data to ensure a confidence level of subsequent separation results. Performing macrogenome assembly on each of the samples after quality control treatment, individually assembling the samples, combining a mixed assembled open reading frame among the samples, performing gene clustering, removing redundancy, taking the longest sequence in each cluster as a representative sequence to obtain a non-redundant gene catalogue; annotating resistance genes on the samples with drug resistance, and labeling bacterial drug resistance genes from different environmental sources with a drug resistance gene database of CARD (The Complementary Antibiotic Resistance Database), to obtain gene annotations of various resistance mechanism roles and corresponding number of resistance mechanism genes.

### Embodiment 1

A method for preparing a modified natural wood material includes the following steps:

S1. placing wood into a lignin removal solution, reacting in an oil bath at a temperature of 100° C. for 8 h, washing the wood 3 times with deionized water, then placing and impregnating the wood into the deionized water for 12 h, then pre-freezing the wood at a temperature of −20° C. for 24 h, lyophilizing the wood for 12 h to obtain a lignin removal wood;
performing low-speed ball-milling mixing on TiO₂ and NaBH₄ with a molar ratio of TiO₂ to NaBH₄ of 1.25:1, placing TiO₂ and NaBH₄ into a corundum crucible, heating to 350° C. at a rate of 10° C./min under an argon atmosphere, cooling to a room temperature after reaction for 1 h, then washing 3 times with the deionized water and anhydrous ethanol, respectively, and drying in an oven at a temperature of 60° C. to obtain reduced black titanium;

S2. placing 0.5 g of the reduced black titanium in 5 mL of the anhydrous ethanol, ultrasonically dispersing for 30 min, then coating dropwise and modifying on the lignin removal wood for 3 times, and drying in the oven at the temperature of 60° C. to obtain the modified natural wood material.

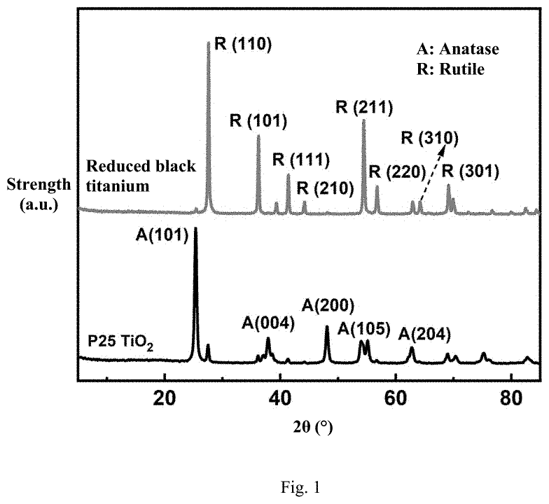

FIG. 1 showed a diagram of XRD results for detecting the reduced black titanium prepared for P25 TiO₂ and step S1. It could be seen that a main crystalline form of the reduced black titanium prepared by the present invention was completely converted from an anatase phase in P25 TiO₂ to a rutile phase.

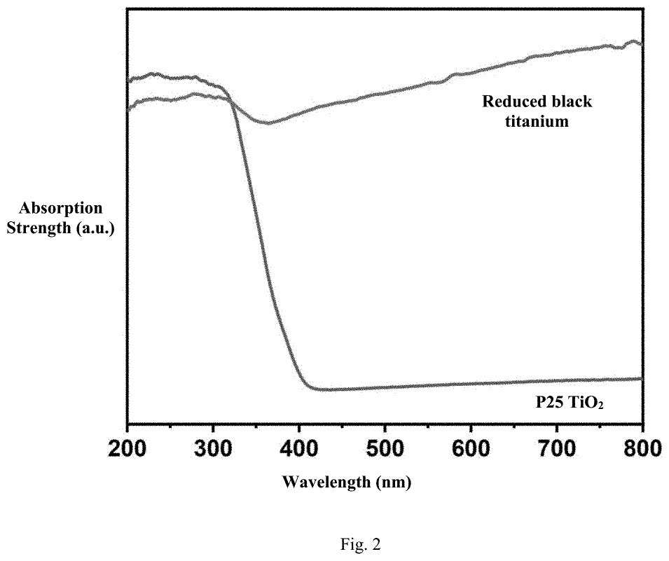

FIG. 2 showed an ultraviolet-visible diffuse reflection spectrum diagram of the reduced black titanium prepared for P25 TiO₂ and step S1. According to an intercept of a curve on horizontal coordinates, it could be calculated that P25 TiO₂ had a bandgap of about 3.21 eV, and the reduced black titanium prepared by the present invention had a bandgap of about 2.15 eV.

### Embodiment 2

A method for preparing a modified natural wood material includes the following steps:

S1. placing wood into a lignin removal solution, reacting in an oil bath at a temperature of 110° C. for 9 h, washing the wood 3 times with deionized water, then placing and impregnating the wood into the deionized water for 12 h, then pre-freezing the wood at a temperature of −20° C. for 24 h, lyophilizing the wood for 12 h to obtain a lignin removal wood;
performing low-speed ball-milling mixing on TiO₂ and NaBH₄ with a molar ratio of TiO₂ to NaBH₄ of 1.2:1, placing TiO₂ and NaBH₄ into a corundum crucible, heating to 340° C. at a rate of 10° C./min under an argon atmosphere, cooling to a room temperature after reaction for 1.2 h, then washing 3 times with the deionized water and anhydrous ethanol, respectively, and drying in an oven at a temperature of 60° C. to obtain reduced black titanium;

S2. placing 0.5 g of the reduced black titanium in 5 mL of the anhydrous ethanol, ultrasonically dispersing for 20 min, then coating dropwise and modifying on the lignin removal wood for 3 times, and drying in the oven at the temperature of 60° C. to obtain the modified natural wood material.

### Embodiment 3

A method for preparing a modified natural wood material includes the following steps:

S1. placing wood into a lignin removal solution, reacting in an oil bath at a temperature of 120° C. for 10 h, washing the wood 3 times with deionized water, then placing and impregnating the wood into the deionized water for 12 h, then pre-freezing the wood at a temperature of −20° C. for 24 h, lyophilizing the wood for 12 h to obtain a lignin removal wood;

performing low-speed ball-milling mixing on TiO₂ and NaBH₄ with a molar ratio of TiO₂ to NaBH₄ of 1.5:1, placing TiO₂ and NaBH₄ into a corundum crucible, heating to 330° C. at a rate of 10° C./min under an argon atmosphere, cooling to a room temperature after reaction for 1.5 h, then washing 3 times with the deionized water and anhydrous ethanol, respectively, and drying in an oven at a temperature of 60° C. to obtain reduced black titanium;

S2. placing 0.5 g of the reduced black titanium in 5 mL of the anhydrous ethanol, ultrasonically dispersing for 40 min, then coating dropwise and modifying on the lignin removal wood for 3 times, and drying in the oven at the temperature of 60° C. to obtain the modified natural wood material.

### Comparative Embodiment 1

Comparative Embodiment 1 was distinct from Embodiment 1 in that in step S1, reduced black titanium was prepared using a vacuum high heat method, which included the following specific steps: placing 1 g of TiO₂ in 5 mL of anhydrous ethanol, ultrasonically dispersing for 30 min, extracting, filtering and washing a TiO₂ dispersion liquid with the anhydrous ethanol and deionized water, drying a filter cake in an oven at a temperature of 60° C., then placing the resulting TiO₂ in a corundum crucible, heating to 800° C. at a rate of 5° C./min under vacuum conditions, reacting for 5 h, cooling to a room temperature, restoring a pressure to a normal pressure when cooling to 200° C., washing with the deionized water and the anhydrous ethanol, and drying in the oven at the temperature of 60° C. to obtain the reduced black titanium. The remaining steps of the preparation method were the same as those in Embodiment 1.

### Comparative Embodiment 2

Comparative Embodiment 2 was distinct from Embodiment 1 in that in step S1, reduced black titanium was prepared using a high heat reduction method, which included the following specific steps: ultrasonically washing and drying 1 g of TiO₂, then placing the TiO₂ in a corundum crucible, heating to 800° C. at a rate of 10° C./min under an argon atmosphere, reacting for 2 h, and cooling to room temperature to obtain the reduced black titanium. The remaining steps of the preparation methods were the same as those in Embodiment 1.

### Test Embodiment 1

Growth test of general microorganisms in domestic sewage:

coating uniformly 10 μL of the domestic sewage on a LB-agar solid culture medium under aseptic conditions, then incubating in an incubator at a constant temperature of 37° C. for 48 h, and observing growth of the microorganisms on a surface of the culture medium.

Performance test of killing the general microorganisms with a modified natural wood material:
placing 50 mL of the domestic sewage in an evaporation container, placing the modified natural wood materials prepared in Embodiment 1 and Comparative Embodiments 1-2 on an upper surface of the evaporation container, respectively, placing the above container in a condensing device constructed by a transparent spherical glass cover, performing simulation irradiation for 12 consecutive hours under one natural light, collecting a condensed water phase in the condensed glass cover under aseptic conditions, coating uniformly the water phase on a LB-agar solid culture medium, then placing in the incubator to be cultured at a constant temperature of 37° C. for 48 h, and observing the growth of the microorganisms on the surface of the culture medium.

Test Results:

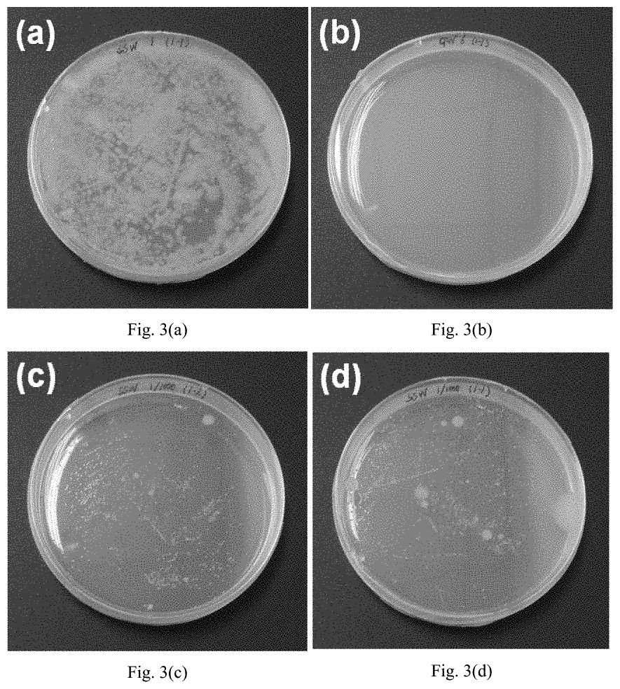

FIG. 3(a) showed a diagram of growth test results of the general microorganisms in the domestic sewage (Blank sample 1). It could be seen that the number of colonies was extremely large and the growth of the microorganisms was rapid.

FIG. 3(b) was a diagram of performance test results of killing the general microorganisms with the modified natural wood material prepared in Embodiment 1. No macroscopic flora was provided, indicating that the modified natural wood material of the present invention had a good performance of killing the microorganisms;

FIG. 3(c) was a diagram of performance test results of killing the general microorganisms with the modified natural wood material prepared in Comparative Embodiment 1. It could be seen that the modified natural wood material prepared in Comparative Embodiment 1 did not effectively kill the microorganisms, and a certain amount of colonies still grew on a surface of a culture medium;

FIG. 3(d) was a diagram of performance test results of killing the general microorganisms with the modified natural wood material prepared in Comparative Embodiment 2. It could be seen that a certain amount of colonies still existed on the surface of the medium, indicating that reduced black titanium completely converted to a rutile phase had a stronger photothermal property than reduced black titanium in which an anatase phase was mixed with the rutile phase, and could promote a photocatalytic process, so as to produce a higher heat value, thereby having a stronger performance of killing the microorganisms.

### Test Embodiment 2

Growth Test of Escherichia coli in Domestic Sewage:

coating uniformly 10 μL of the domestic sewage on a EMB-agar solid culture medium under aseptic conditions, then incubating in an incubator at a constant temperature of 37° C. for 48 h, and observing growth of the Escherichia coli on a surface of the culture medium.

Performance test of killing the Escherichia coli with a modified natural wood material:
placing 50 mL of the domestic sewage in an evaporation container, placing the modified natural wood materials prepared in Embodiment 1 and Comparative Embodiments 1-2 on an upper surface of the evaporation container, respectively, placing the above container in a condensing device constructed by a transparent spherical glass cover, performing simulation irradiation for 12 consecutive hours under one natural light, collecting a condensed water phase in the condensed glass cover under aseptic conditions, coating uniformly the water phase on a EMB-agar solid culture medium, then placing in the incubator to be cultured at a constant temperature of 37° C. for 48 h, and observing the growth of the Escherichia coli on the surface of the culture medium. The number of oxygen-containing radical in the modified natural wood material prepared in Embodiment 1 was then detected using an electron-paramagnetic resonator under visible light simulated light source excitation and unirradiated conditions.

Test Results:

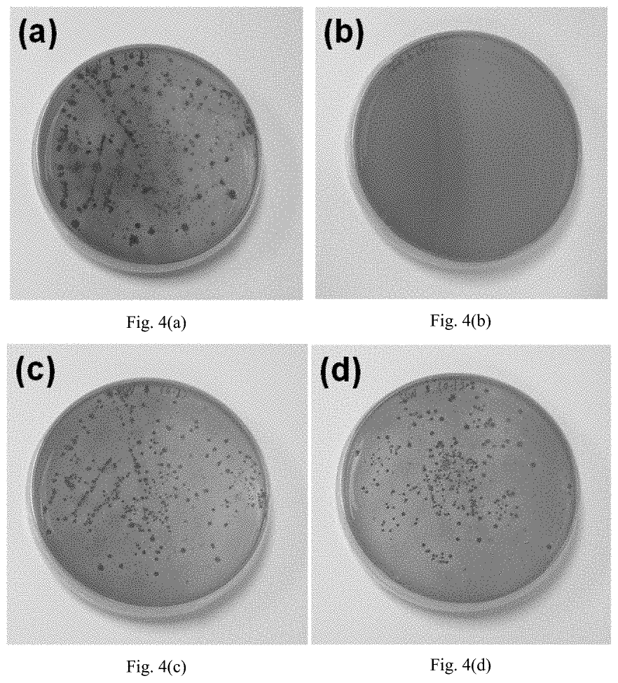

FIG. 4(a) was a diagram of growth test results of the Escherichia coli in the domestic sewage (Blank sample 2). It could be seen that a large number of metallic coliforms existed on the surface of the culture medium.

FIG. 4(b) was a diagram of performance test results of killing the Escherichia coli with the modified natural wood material prepared in Embodiment 1. No macroscopic coliforms was provided, indicating that the modified natural wood material of the present invention had a good performance of killing the Escherichia coli.

FIG. 4(c) was a diagram of performance test results of killing Escherichia coli with the modified natural wood material prepared in Comparative Embodiment 1. It could be seen that the modified natural wood material prepared in Comparative Embodiment 1 failed to effectively and selectively kill the coliforms.

FIG. 4(d) was a diagram of performance test results of killing the Escherichia coli with the modified natural wood material prepared in Comparative Embodiment 2. It could be seen that the modified natural wood material prepared in Comparative Embodiment 2 failed to effectively and selectively kill the coliforms.

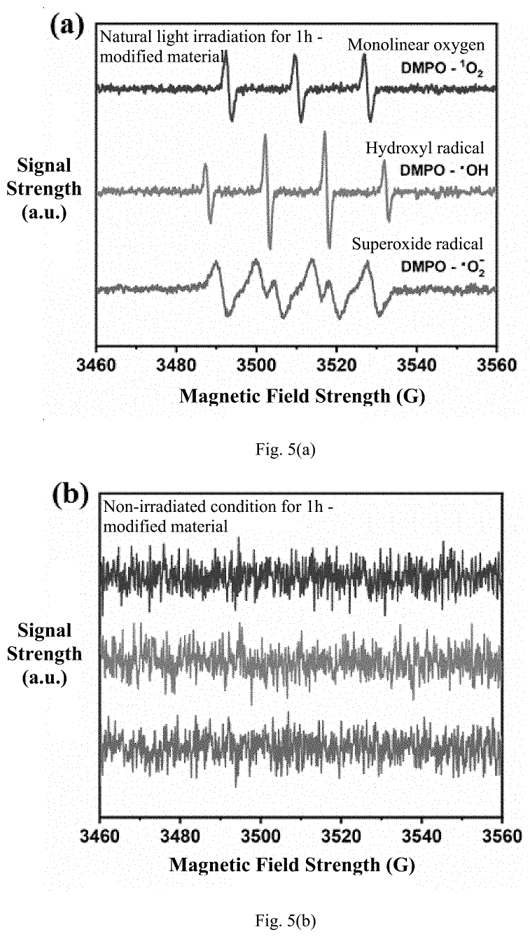

Detection test results of the quantity of the oxygen-containing radical were shown in Table 1 and FIG. 5:

TABLE 1
Detection Test Results of Quantity of the Oxygen-containing Radical

| | Signal Strength (a.u.) | | | | | |
|---|---|---|---|---|---|---|
| Magnetic Field | Irradiation of One Natural Light for 1 h | | | No Irradiation | | |
| Strength (G) | DMPO—¹O₂ | DMPO—•OH | DMPO—O₂⁻ | DMPO—¹O₂ | DMPO—•OH | DMPO—O₂⁻ |
| 3492.36 | 125656.73 | / | / | / | / | / |
| 3509.46 | 123723.74 | / | / | / | / | / |
| 3526.96 | 123912.97 | / | / | / | / | / |
| 3487.17 | / | 66153.50 | / | / | / | / |
| 3502.13 | / | 81615.59 | / | / | / | / |
| 3517.08 | / | 83045.52 | / | / | / | / |
| 3531.94 | / | 67987.02 | / | / | / | / |
| 3489.91 | / | / | 14987.89 | / | / | / |
| 3499.88 | / | / | 16126.63 | / | / | / |
| 3513.76 | / | / | 16150.10 | / | / | / |
| 3527.74 | / | / | 15062.60 | / | / | / |

FIG. 5 showed a diagram of detection results of the oxygen-containing radical produced by the modified natural wood material. FIG. 5(a) showed a magnetic field intensity-signal intensity curve of the oxygen-containing radical produced by the modified natural wood material under irradiation of one natural light for 1 h. It could be seen that the modified natural wood material utilized surface modification to reduce the black titanium components, which could produce the oxygen-containing radical such as monolinear oxygen, hydroxyl radical, and superoxide radical under visible light excitation, and could be used efficiently for sterilization of domestic sewage microorganisms. FIG. 5(b) showed a magnetic field intensity-signal intensity curve of the oxygen-containing radical produced by the modified natural wood material under unirradiated conditions. It could be seen that even with the modification of the reduced black titanium components, the modified natural wood material could not produce the oxygen-containing radical under the unirradiated conditions. It was indicated that light excitation was also critical for the production of the oxygen-containing radical.

### Test Embodiment 3

Test of Bio-Risk Component Contents in Domestic Sewage:

Taking 50 mL of the domestic sewage as a sample and performing a macrogenome-antibiotic resistance gene test on the sample.

Test of an enrichment separation effect of bio-risk components by a modified natural wood material:
treating 50 mL of the domestic sewage as the sample with the modified natural wood materials prepared in Embodiment 1 and Comparative Embodiments 1-2 under one natural light for 15 h, respectively, and then performing a macrogenome-antibiotic resistance gene test on the modified natural wood material.

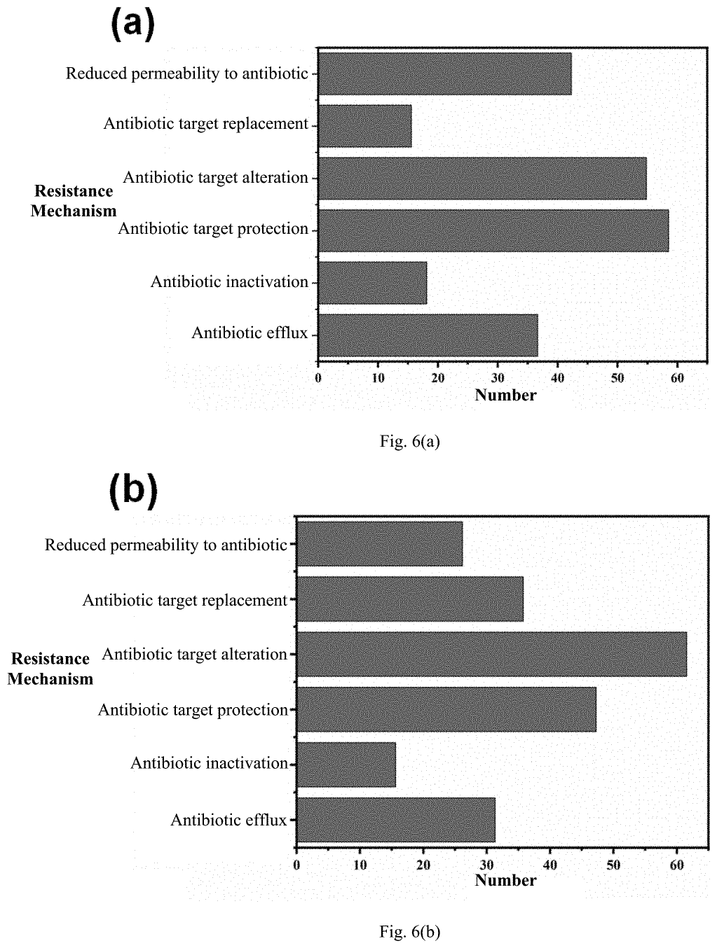

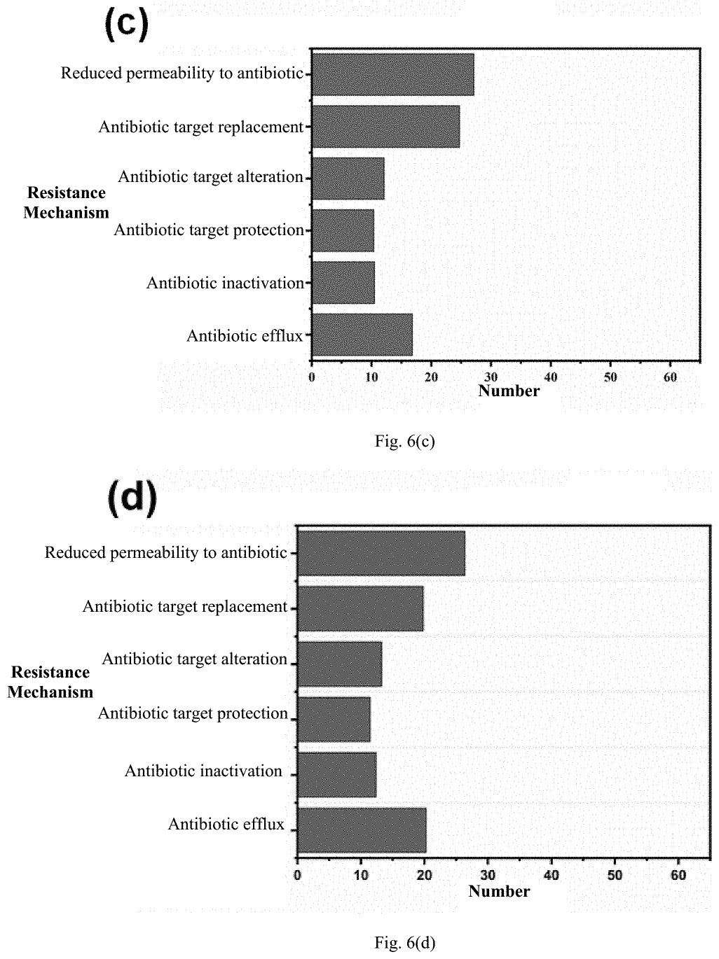

Test results were shown in Table 2 and FIG. 6:

TABLE 2
Macrogenome-antibiotic Resistance Gene Test Results

| | Quantity (Pcs) | | | |
|---|---|---|---|---|
| | | | Comparative | Comparative |
| ARGs | Blank Sample 3 | Embodiment 1 | Embodiment 1 | Embodiment 2 |
| Antibiotic efflux | 36.67 | 31.33 | 16.84 | 20.29 |
| Antibiotic inactivation | 18.13 | 15.63 | 10.50 | 12.36 |
| Antibiotic target | 58.54 | 47.26 | 10.39 | 11.44 |
| protection | | | | |
| Antibiotic target | 54.84 | 61.55 | 12.10 | 13.25 |
| alteration | | | | |
| Antibiotic target | 15.56 | 35.78 | 24.73 | 19.79 |
| replacement | | | | |
| Reduced permeability | 42.28 | 26.17 | 27.13 | 26.39 |
| to antibiotic | | | | |

It could be derived from Table 2 that the modified natural wood material prepared by the present invention has a highly efficient enriching separation capacity on ARG components in the sewage. The number of “antibiotic target alteration” genes in Embodiment 1 was more than that in the blank sample, because the number of resistance genes in the blank sample itself was less. Embodiment 1 was continuously enriched during a process, resulting in the number of enriched partial genes exceeded a corresponding value in the blank sample. The number of “reduced permeability to the antibiotic” genes in Embodiment 1 was lower than the comparative embodiment, which might be due to non-uniformity of a resistance gene-sequencing sample. An enrichment effect of Embodiment 1 on other resistance genes was significantly higher than that of the comparative embodiment. Therefore, it could still be concluded that the present invention had the ability to efficiently separate the bio-risk components.

FIG. 6(a) showed a diagram of test results of bio-risk component contents in the domestic sewage (Blank sample 3). It could be seen that the domestic sewage contained a large number of antibiotic resistance genes and other bio-risk components.

FIG. 6(b) showed a diagram of test results of an enrichment separation effect of the bio-risk components by the modified natural wood material prepared in Embodiment 1. It could be seen that the components and quantity of the modified natural wood material of the present invention was similar to those of the antibiotic resistance gene in untreated domestic sewage, indicating that the antibiotic resistance genes in the domestic sewage were enriched and transferred to the modified natural wood material. The modified natural wood material of the present invention had an efficient removal capacity on the bio-risk components such as the antibiotic resistance gene.

FIGS. 6(c) and 6(d) showed a diagram of the test results of the enrichment separation effect of the modified natural wood materials prepared at Comparative Embodiment 1 and Comparative Embodiment 2 on the bio-risk components. It could be seen that the bio-risk components in domestic sewage could also be enriched and separated by the modified natural wood material prepared in Comparative Embodiment 1 and Comparative Embodiment 2 with a photothermal effect, but an effect was reduced and significantly weaker than that of the modified natural wood material prepared in Embodiment 1.

It is obvious to those skilled in the art that the present invention is not limited to the details of the exemplary embodiments described above, and that the present invention can be realized in other specific forms without departing from the spirit or basic features of the present invention. Therefore, the embodiments should be regarded as exemplary and non-limiting from any standpoint. The scope of the present invention is defined by the appended claims rather than the above description. It is therefore intended that all variations falling within the meaning and scope of equivalent elements of claims be encompassed by the present invention.

In addition, it should be understood that although this specification is described in terms of embodiments, not each embodiment only includes an independent technical solution. This description in the specification is only for the sake of clarity. A person skilled in the art should take the specification as a whole. The technical solutions in each embodiment can also be appropriately combined to form other implementations that can be understood by a person skilled in the art.

1. A method for preparing a modified natural wood material, comprising the following steps:
S1. placing wood into a lignin removal solution, after a heating reaction, washing, impregnating, and lyophilizing the wood to obtain removed lignin wood;
blending TiO₂ with NaBH₄, performing low-heat reduction treatment, and then washing and drying to obtain reduced black titanium;
S2. dispersing the reduced black titanium ultrasonically in a solvent, then coating on the removed lignin wood, and drying to obtain a modified natural wood material;
wherein,
the natural wood material is American lightwood;
the reduced black titanium has a bandgap of 2.10-2.20 eV.

2. The method for preparing the modified natural wood material according to claim 1,
wherein in step S1, the method for preparing the lignin removal solution comprises the following steps: dissolving acetate in water, adjusting pH, and then adding chlorate.

3. The method for preparing the modified natural wood material according to claim 2, wherein a molar ratio of acetate to chlorate is (2.5-3):1.

4. The method for preparing the modified natural wood material according to claim 2, wherein the pH is 4.4-4.8.

5. The method for preparing the modified natural wood material according to claim 1, wherein in step S1, the heating reaction has a temperature of 100-120° C. and time of 8-10 h.

6. The method for preparing the modified natural wood material according to claim 1, wherein in step S1, a molar ratio of TiO₂ to NaBH₄ is (1-1.5):1.

7. The method for preparing the modified natural wood material according to claim 1, wherein in step S1, the method for blending TiO₂ with NaBH₄ is ball-milling mixing.

8. The method for preparing the modified natural wood material according to claim 1, wherein in step S1, the low-heat reduction treatment is performed under an inert gas atmosphere at a temperature of 300-350° C. for 1-1.5 h.

9. The method for preparing the modified natural wood material according to claim 1, wherein in step S2, ultrasonic dispersion has time of 20-40 min.

10. An application of the modified natural wood material of claim 1 in sewage treatment.
